(19) United States
(12) Patent Application Publication
(10) Pub. No.: US 2013/0290486 A1
(43) Pub. Date: Oct. 31, 2013

(54) COMMUNICATION DEVICE

(71) Applicant: Tomoaki Ishiyama, Tokyo (JP)

(72) Inventor: Tomoaki Ishiyama, Tokyo (JP)

(73) Assignee: MITSUBISHI ELECTRIC CORPORATION, Chiyoda-ku, Tokyo (JP)

(21) Appl. No.: 13/978,074

(22) PCT Filed: Feb. 28, 2011
(86) PCT No.: PCT/JP2011/054512

§ 371 Date: Jul. 2, 2013

(51) Int. Cl. H04L 29/08

(52) U.S. Cl. CPC H04L 67/02
USPC 709/217

(57) ABSTRACT

A communication device includes a command-message analysis unit that determines whether a command message received via a network is a command-registration command message based on a command part of the received command message, a storage unit that stores therein a command-message issuing condition, a command-message issuing destination, and a to-be-issued command message included in a data part of command-registration command message and associated with each other when the communication device receives the command-registration command message, a command-message issuing-condition-satisfaction determination unit that detects that the command-message issuing condition stored in the storage unit is satisfied, and a command-message issuing unit that transmits the to-be-issued command message associated with the satisfied command issuing condition to the command-message issuing destination associated with the satisfied command-message issuing condition as a destination.

### FIELD

The present invention relates to a communication device.

### BACKGROUND

There is known command message-based communication that is a method widely used as a network communication method.

The command message-based communication is to transmit a command for issuing an instruction to a communication device as well as information data necessary to process the command to a target communication device (a target device) and to thereby execute the instruction to change an operation of the target device, read or write of internal data from or to the target device, or other instructions to the target device. The command and the information data added to the command are defined in advance by specifications of a communication protocol to be used.

Two conventional methods are known as follows in a case of executing the command message-based communication. (1) A method in which a user creates an execution program to issue a command message and to write the execution program to the communication device, whereby the communication device issues the command message according to the program. (2) A method in which the communication device is connected to a computer and a command-message transmission instruction is issued from a software application of the computer to the communication device, thereby issuing the command message from the communication device.

Furthermore, Patent Literature 1 discloses an invention of reading data from a read target device the name of which is registered in a registration area at intervals of periodic time registered in the registration area and periodically and automatically transmitting the data to a network-connected general-purpose device.

### CITATION LIST

### Patent Literature

Patent Literature 1: Japanese Patent Application Laid-open No. H11-305810

### SUMMARY

### Technical Problem

The method (1) entails a working cost to create the execution program for issuing the command message and to perform a debugging work. Development software for programming is often unique to each communication device manufacturer. Owing to this, in the case of a system in which communication devices manufactured by a plurality of meters are mixed together, the user is required to spend much time to learn how to use plural pieces of software.

Although the method (2) does not need to use the execution program, a user needs to perform an operation whenever a command message is issued and it is therefore difficult to automatically issue the command message.

The invention described in Patent Literature 1 requires a program for interpreting the data received by a destination. Therefore, similarly to the method (1), the invention described in Patent Literature 1 entails a working cost to create the data interpretation program and to perform a debugging work.

The present invention has been achieved to solve the above problems, and an object of the present invention is to provide a communication device capable of automatically issuing a command message to another communication device according to an issuing condition without the need of a program created by a user.

### Solution to Problem

In order to solve the above problem and in order to attain the above object, in a communication device used as a node by a network system in which a command message including a command part that indicates a type of a process defined by a communication protocol in advance and a data part that is a processing target of the process of the type designated by the command part is transmitted or received among a plurality of nodes connected to one another via a network, and in the communication device used as one of the nodes, the communication device of the present invention includes: a unit that determines whether the command message received via the network is a command-registration command message based on the command part of the received command message; a storage unit that stores therein a command issuing condition, a command-message issuing destination, and a to-be-issued command message included in the data part of the command-registration command message and associated with each other when the communication device receives the command-registration command message; a unit that detects that the command issuing condition stored in the storage unit is satisfied; and a unit that transmits the to-be-issued command message associated with the satisfied command issuing condition to the command-message issuing destination associated with the satisfied command issuing condition as a destination.

### Advantageous Effects of Invention

The communication device according to the present invention is capable of automatically issuing a command message to another communication device according to an issuing condition without the need of a program created by a user for the communication device simply by issuing a registration command message including information on a command-message issuing condition, a command-message issuing destination, and a to-be-issued command message to a target communication device.

### BRIEF DESCRIPTION OF DRAWINGS

FIG. 1 depicts a configuration of a communication device according to an embodiment of the present invention.

FIG. 2 is an example of a configuration of a system using the communication devices according to the present embodiment.

FIG. 3 depicts a format of a command-registration command message transmitted from a computer to the communication device.

FIG. 4 is an example of data stored in a storage unit.

FIG. 5 is a flowchart of a process performed in the communication device when a command-message issuing condition, a command-message issuing destination, and a to-be-issued command message are stored in the storage unit.

### DESCRIPTION OF EMBODIMENTS

Exemplary embodiments of a communication device according to the present invention will be explained below in detail with reference to the accompanying drawings. The present invention is not limited to the embodiments.

### Embodiment

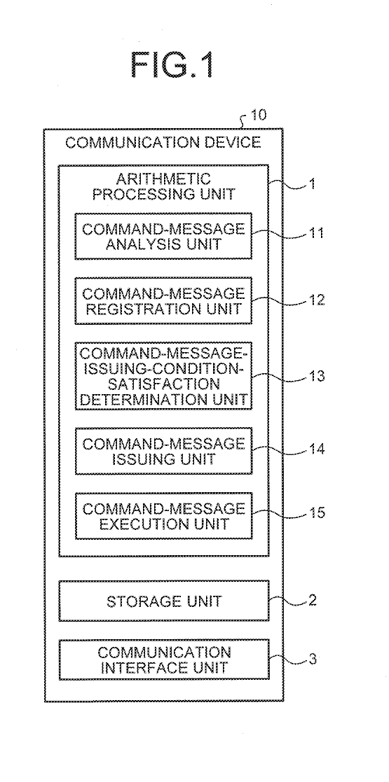

FIG. 1 depicts a configuration of a communication device according to an embodiment of the present invention. A communication device 10 includes an arithmetic processing unit 1, a storage unit 2, and a communication interface unit 3. The arithmetic processing unit 1 includes an arithmetic processor such as a CPU, a memory used by the arithmetic processor as a work area, and the like, as hardware. Functionally, the arithmetic processing unit 1 includes a command-message analysis unit 11, a command-message registration unit 12, a command-message issuing-condition-satisfaction determination unit 13, a command-message issuing unit 14, and a command-message execution unit 15. The command-message analysis unit 11 analyzes a command message received from another communication device on the same network and determines whether the received command message is a registration command message. The command-message registration unit 12 stores a command-message issuing condition, a command-message issuing destination, and a to-be-issued command message that are included in the received registration command message in the storage unit 2. The command-message issuing-condition-satisfaction determination unit 13 monitors whether the command-message issuing condition stored in the storage unit 2 is satisfied. The command-message issuing unit 14 issues the command message related to the satisfied command-message issuing condition to a communication device registered as an issuing destination when the command-message condition is satisfied. The command-message execution unit 15 executes the command message related to the satisfied command-message issuing condition when the command-message issuing condition is satisfied. When the command message received from another communication device is a normal command message, the command-message execution unit 15 executes the received command message. The storage unit 2 stores therein information on the command message, the command-message issuing condition, and the command-message issuing destination. The communication interface unit 3 transmits data to a network and receives data from the network.

When the communication device 10 receives data from an external network via the communication interface unit 3, the command-message analysis unit 11 analyzes the received data and determines whether the received data is the registration command message. When the received data is the registration command message, the command-message registration unit 12 stores the command-message issuing condition, the command-message issuing destination, and the to-be-issued command message included in the command message in the storage unit 2. The command-message analysis unit 11 includes a table that associates a command number allocated individually to each command message with a command (a process) corresponding to the command number, and determines whether the data received from the external network is the registration command message based on this table.

As for the command-message issuing condition stored in the storage unit 2, the command-message issuing-condition-satisfaction determination unit 13 determines whether the command-message issuing condition is satisfied either regularly or at arbitrary timing. When the command-message issuing-condition-satisfaction determination unit 13 detects that the command-message issuing condition is satisfied and when the command-message issuing destination is another node (another communication device), the command-message issuing unit 14 transmits the command message stored in the storage unit 2 to the command-message issuing destination stored in the storage unit 2 via the communication interface unit 3. When the command-message issuing destination is a self-node (the self-communication device) at the time of satisfaction of the command-message issuing condition, the command-message execution unit 15 executes processing of the command message (a command message process).

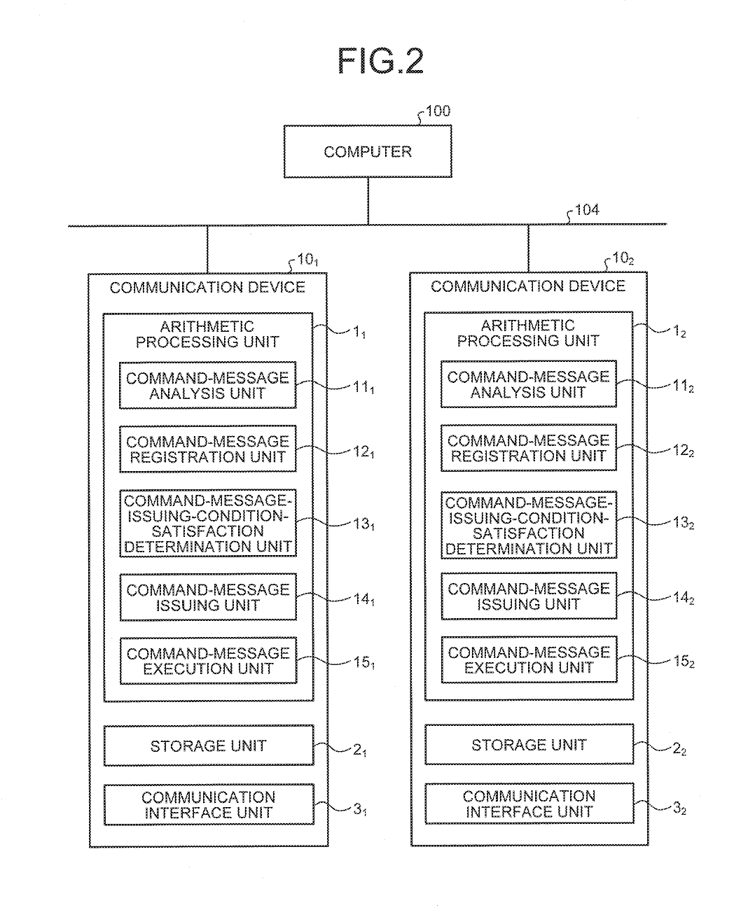

FIG. 2 is an example of a configuration of a system using the communication devices according to the present embodiment. A computer 100 and communication devices 10₂ and 10₂ serving as nodes are connected to one another via a network 104. The communication devices 10₂ and 10₂ are similar in configuration to the communication device 10 shown in FIG. 1. In the following descriptions, when it is necessary to distinguish the communication devices 10, the arithmetic processing units 1, the storage units 2, and the communication interface units 3, an index 1 or 2 is added to each reference symbol. While FIG. 2 depicts a system configured to include the two communication devices 10₂ and 10₂ by way of example, the system can be configured to include three or more communication devices.

The computer 100 includes a communication interface for connecting the computer 100 to the network 104 and software including a user interface that designates a target communication device 10 and that designates a command-message issuing condition, a command-message issuing destination, and a to-be-issued command message, and a communication driver for transmitting a registration command message to the target device.

Each of the communication devices 10₂ and 10₂ includes a function of processing transmission and reception of a command message according to a common communication protocol. No problem occurs even if manufacturers of the software included in the computer 100, the communication device 10₁, and the communication device 10₁ differ from one another.

The user interface of the software of the computer 100 designates the command-message issuing condition, the command-message issuing destination, and the to-be-issued command message, and the computer 100 transmits a command message for command registration (a command-registration command message) to the communication device 10₁ executing the command registration via the network 104.

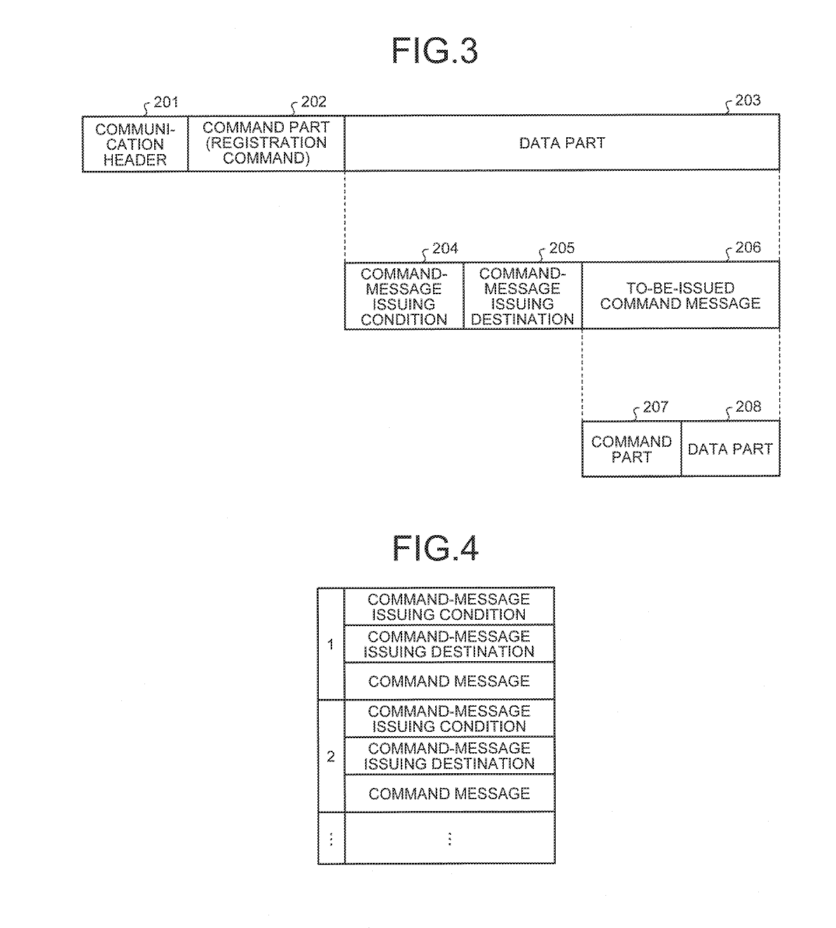

FIG. 3 depicts a format of the command-registration command message transmitted from the computer 100 to the communication device 10₁. The command message is constituted by a communication header 201, a command part 202, and a data part 203. A command number that signifies a registration command is designated in the command part 202. The data part 203 is constituted by a command-message issuing condition 204, a command-message issuing destination 205, and a to-be-issued command message 206. The to-be-issued command message 206 is constituted by a command part 207 and a data part 208.

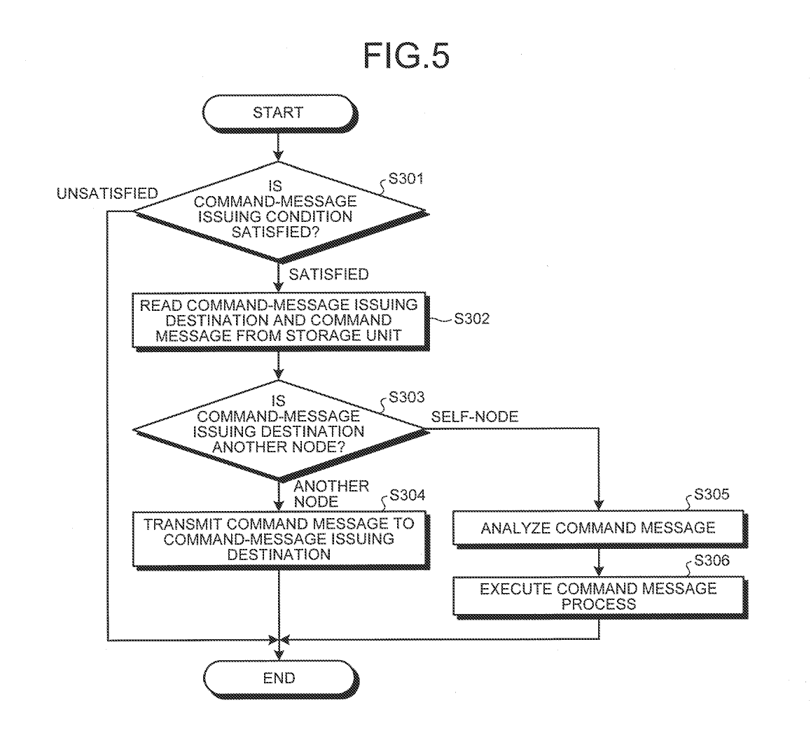

When the communication device 10₁ receives a command message from the computer 100, a command-message analysis unit 11₁ determines whether the received command message is a command-registration command message based on the command number designated in the command part 202. When the communication device 10₁ receives a command-registration command message (a registration command message) from the computer 100 through a communication interface unit 3₁, a command-message registration unit 12₁ stores the command-message issuing condition 204, the command-message issuing destination 205, and the to-be-issued command message 206 included in the received registration command message, in a storage unit 2₁ as a group. FIG. 4 is an example of data stored in the storage unit 2₁. As shown in FIG. 4, a plurality of groups each including one command-message issuing condition, one command-message issuing destination, and one to-be-issued command message can be stored in the storage unit 2₁.

FIG. 5 is a flowchart of a process performed in the communication device 10₁ when the command-message issuing condition, the command-message issuing destination, and the to-be-issued command message are stored in the storage unit 2₁. A command-message issuing-condition-satisfaction determination unit 13₁ determines whether the command-message issuing condition stored in the storage unit 2₁ is satisfied either regularly or at arbitrary timing (Step S301). When the command-message issuing-condition-satisfaction determination unit 13₁ detects that the command-message issuing condition is satisfied (SATISFIED at Step S301), an arithmetic processing unit 1₁ reads the command-message issuing destination and the to-be-issued command message that are stored as a group to which the satisfied command-message issuing condition also belongs from the storage unit 2₁ (Step S302). When the command-message issuing-condition-satisfaction determination unit 13₁ does not detect that the command-message issuing condition is satisfied (UNSATISFIED at Step S301), the process ends.

The arithmetic processing unit 1₁ determines whether the command-message issuing destination read from the storage unit 2₁ is another node (Step S303). When the issuing destination is another node (another device, which is the communication device 10₂ in this example) (ANOTHER NODE at Step S303), a command-message issuing unit 14₁ adds the command message read from the storage unit 2₁ to a communication header and transmits a resultant command message to the command-message issuing destination that is read by the arithmetic processing unit 1₁ from the storage unit 2₁ (Step S304). When the command-message issuing destination read by the arithmetic processing unit 1₁ from the storage unit 2₁ is the self-node (the communication device 10₁) (SELF-NODE at Step S303), the command-message execution unit 15 analyzes the to-be-issued command message read by the arithmetic processing unit 1₁ from the storage unit 2₁ (Step 5305) and executes the command message process (Step S306).

When the communication device 10₂ receives the command message transmitted from the communication device 10₁, a command-message analysis unit 11₂ analyzes the received command message and a command-message execution unit 15₂ executes the command message process.

In this way, according to the present embodiment, a command storing the command-registration command message is defined as a communication protocol. Therefore, the communication device can automatically issue the command message at arbitrary timing only by simple settings through the user interface of the software or the like on the computer without the need of a user-created program.

As for the settings through the user interface of the software or the like on the computer, the settings can be directly performed through one user interface to a plurality of communication devices different in manufacturer.

Furthermore, by registering a command message to be issued to the self-node, even a communication device that does not include a user-programming-based advanced control function is capable of realizing a simple self control function without the need of a program.

### REFERENCE SIGNS LIST

1 arithmetic processing unit

2 storage unit

3 communication interface unit

10 communication device

11 command-message analysis unit

12 command-message registration unit

13 command-message issuing-condition-satisfaction determination unit

14 command-message issuing unit

15 command-message execution unit

100 computer

104 network

201 communication header

202, 207 command part

203, 208 data part

204 command issuing condition

205 command issuing destination

206 to-be-issued command message

1. A communication device used as a node by a network system in which a command message including a command part that indicates a type of a process defined by a communication protocol in advance and a data part that is a processing target of the process of the type designated by the command part is transmitted or received among a plurality of nodes connected to one another via a network, the communication device used as one of the nodes, the communication device comprising:
a unit that determines whether the command message received via the network is a command-registration command message defined as the communication protocol based on the command part of the received command message;
a storage unit that stores therein a command-message issuing condition, a command-message issuing destination, and a to-be-issued command message defined as the communication protocol included in the data part of the command-registration command message and associated with each other when the communication device receives the command-registration command message;
a unit that detects that the command-message issuing condition stored in the storage unit is satisfied; and
a unit that transmits the to-be-issued command message associated with the satisfied command-message issuing condition to one of the nodes connected to one another via the network and designated by the command-message issuing destination associated with the satisfied command-message issuing condition as a destination.

2. The communication device according to claim 1, wherein the to-be-issued command message associated with the satisfied command-message issuing condition is executed when the command-message issuing destination associated with the satisfied command-message issuing condition is a self-node that is the communication device.
